(19) United States
(12) Patent Application Publication
(10) Pub. No.: US 2021/0374684 A1
(43) Pub. Date: Dec. 2, 2021

(54) Dynamic Recommendation Engine

(71) Applicant: Citrix Systems, Inc., Fort Lauderdale, FL (US)

(72) Inventors: Zongpeng Qiao, Nanjing (CN); Tao Zhan, Nanjing (CN); Ze Chen, Nanjing (CN)

(21) Appl. No.: 17/003,427

(22) Filed: Aug. 26, 2020

Related U.S. Application Data
(63) Continuation of application No. PCT/CN20/93934, filed on Jun. 2, 2020.

(51) Int. Cl. G06Q 10/10; G06Q 10/06; G06N 20/00

(52) U.S. Cl. CPC G06Q 10/1095; G06N 20/00; G06Q 10/06311

(57) ABSTRACT

Methods and systems for generating recommendations for events are described herein. A computing device may assist a user that is trying to schedule an event by generating recommendations for one or more aspects of the event. Participant's schedule information, event preferences, and/or other information may be used to determine a recommendation for an event. A recommendation may include a time that meets the availability and/or preferences of the participants. A recommendation may indicate one or more participants that should be invited to the event and/or one or more participants that should not be invited to the event.

### CROSS REFERENCE TO RELATED APPLICATIONS

This application claims priority to International Application No. PCT/CN2020/093934, filed Jun. 2, 2020, and entitled “Dynamic Recommendation Engine,” which is hereby incorporated by reference in its entirety.

### FIELD

Aspects described herein generally relate to computer networking, remote computer access, virtualization, artificial intelligence, and hardware and software related thereto. More specifically, one or more aspects describe herein provide recommendations for events.

### BACKGROUND

Users from many different locations around the world may wish to collaborate with each other. Events may be scheduled with participants around the world. It may be difficult to determine an appropriate time to schedule an event.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards generating recommendations for events. A computing device may assist a user that is trying to schedule an event by generating recommendations for one or more aspects of the event. Participant's schedule information, event preferences, and/or other information may be used to determine a recommendation for an event. A recommendation may include a time that meets the availability and/or preferences of the participants. A recommendation may indicate one or more participants that should be invited to the event and/or one or more participants that should not be invited to the event.

In one aspect, a computer implemented method may include receiving, by a server and from a user device, a request to schedule an event, wherein the request indicates a first plurality of participants for the event; receiving participant preference information corresponding to the plurality of participants, wherein the participant preference information indicates, for each participant, a type of event and a preferred time for the type of event, wherein the type of event indicates a second plurality of participants associated with the type of event; receiving scheduling information corresponding to the first plurality of participants, wherein the scheduling information indicates availability for each participant of the first plurality of participants; generating, based on the participant preference information and the scheduling information, a recommendation for a time to schedule the event; and sending the recommendation to the user device.

The method may further include determining a level of necessity for each participant of the plurality of participants; and weighting, based on the level of necessity for each participant, participant preference information of the plurality of participants, wherein the recommendation is based on the weighting. The participant preference information may further indicate a second type of event and a time when the second type of event should not occur. The receiving scheduling information corresponding to the first plurality of participants may include receiving scheduling information from a plurality of systems.

The method may further include determining, based on a time indicated by the request and the scheduling information, that the time corresponds to a non-preferred time of a first participant of the first plurality of participants; and sending, to the user device, a recommendation to remove the first participant. The recommendation to remove the first participant may be based on a determination of a level of necessity of the first participant.

The method may further include: determining, based on time indicated by the request and the participant preference information, that a first participant of the first plurality of participants is unavailable; determining, based on employee information of the first participant and a machine learning model, a similarity metric that compares the first participant and a replacement participant; and sending, based on a determination that the similarity metric exceeds a threshold, a recommendation to replace the first participant with the replacement participant.

In some aspects, a system may be configured to perform one or more aspects and/or methods described herein. In some aspects, an apparatus may be configured to perform one or more aspects and/or methods described herein. In some aspects, one or more computer readable media may store computer executed instructions that, when executed, configure a system to perform one or more aspects and/or methods described herein. These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 5C is a block diagram similar to that shown in FIG. 5B but in which the available resources are represented by a single box labeled “systems of record,” and further in which several different services are included among the resource management services.

FIG. 6 depicts an example system for generating schedule recommendations that may be used in accordance with one or more illustrative aspects described herein.

FIG. 7 depicts example schedules of participants that may be used in accordance with one or more illustrative aspects described herein.

FIG. 8 depicts an example schedule data that may be used in accordance with one or more illustrative aspects described herein.

FIG. 9 depicts an example method for generating schedule recommendations that may be used in accordance with one or more illustrative aspects described herein.

FIGS. 10A-10B depict an example method for generating schedule recommendations that may be used in accordance with one or more illustrative aspects described herein.

FIGS. 11A-11B show example graphical user interfaces that may be used in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

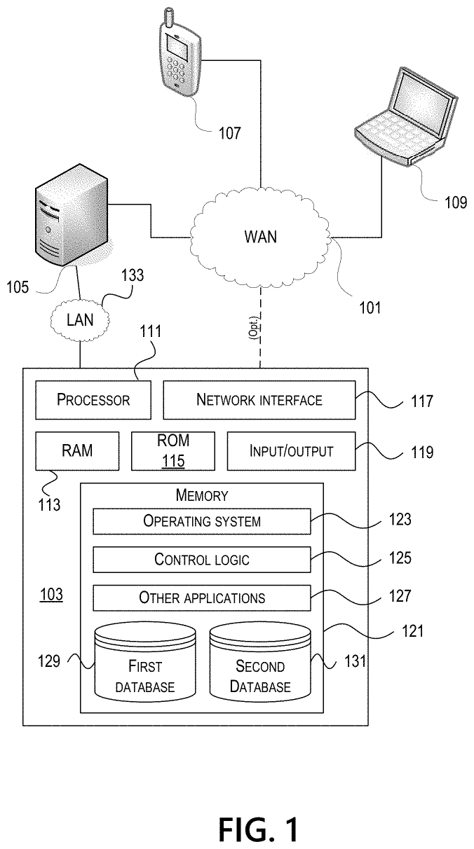

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

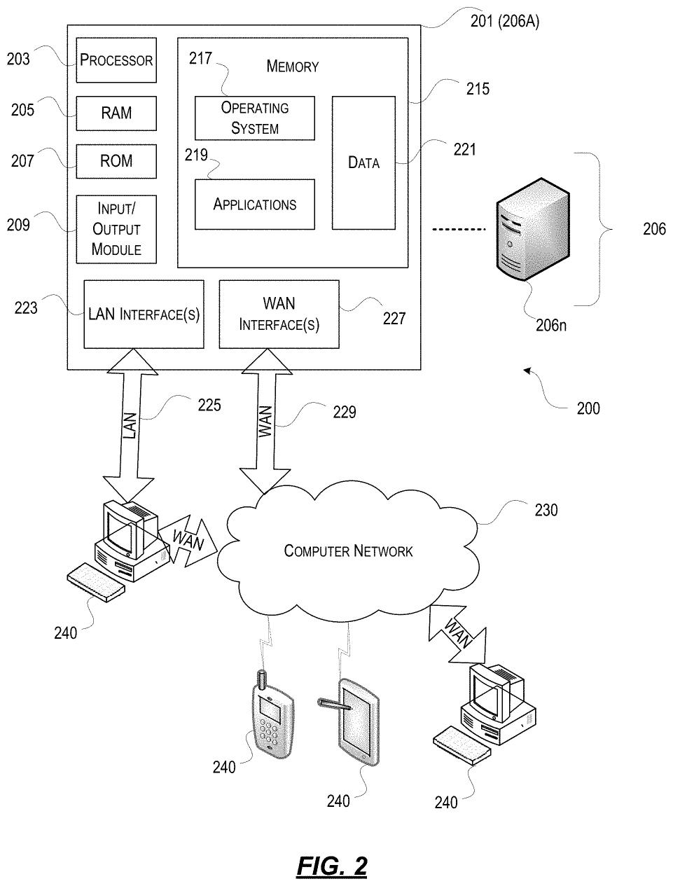

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 103 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

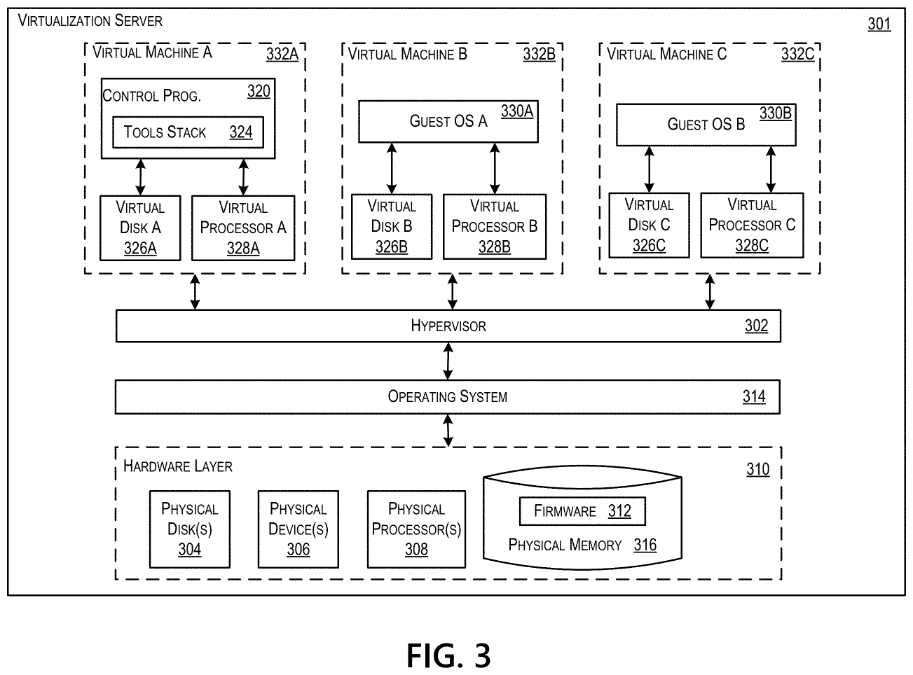

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

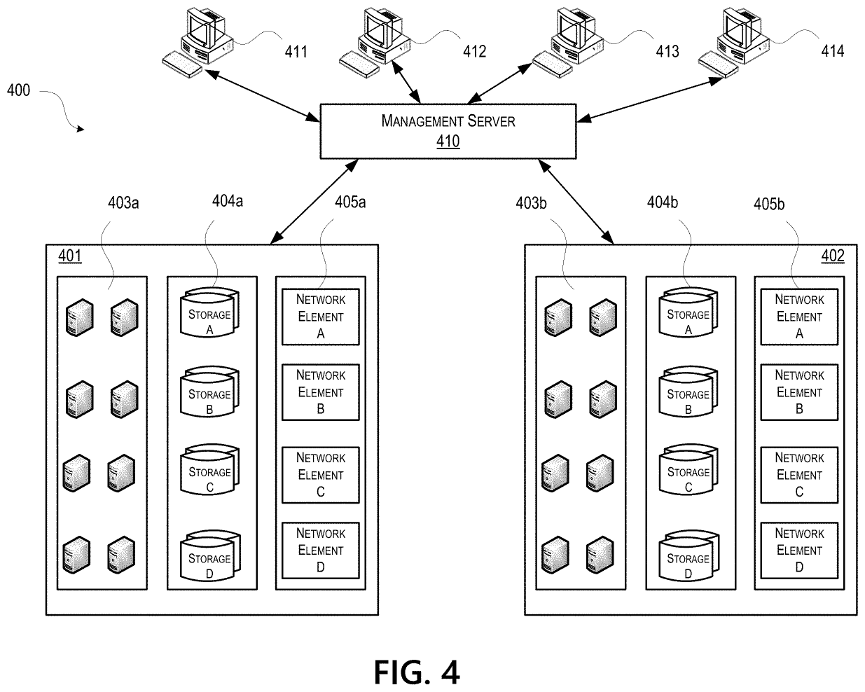

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

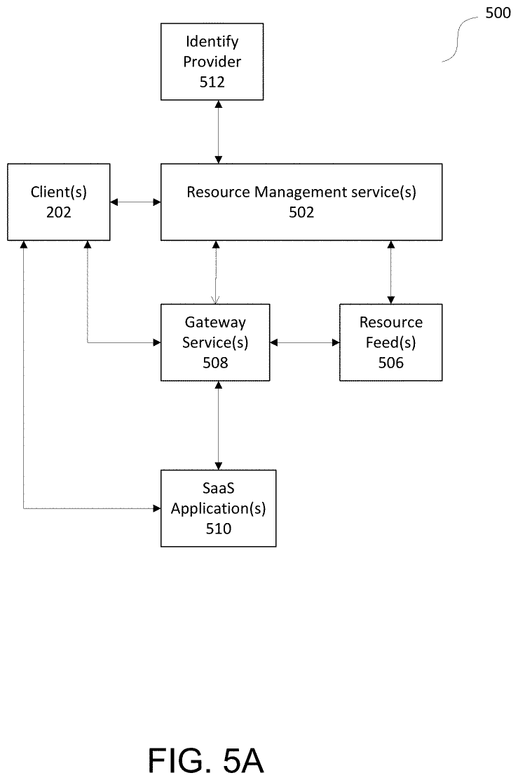

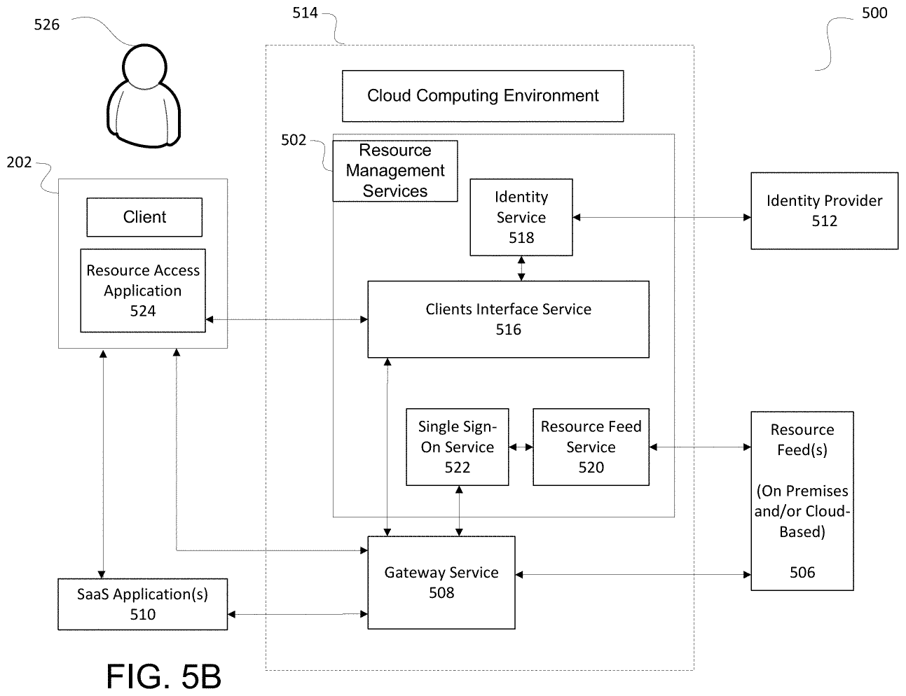

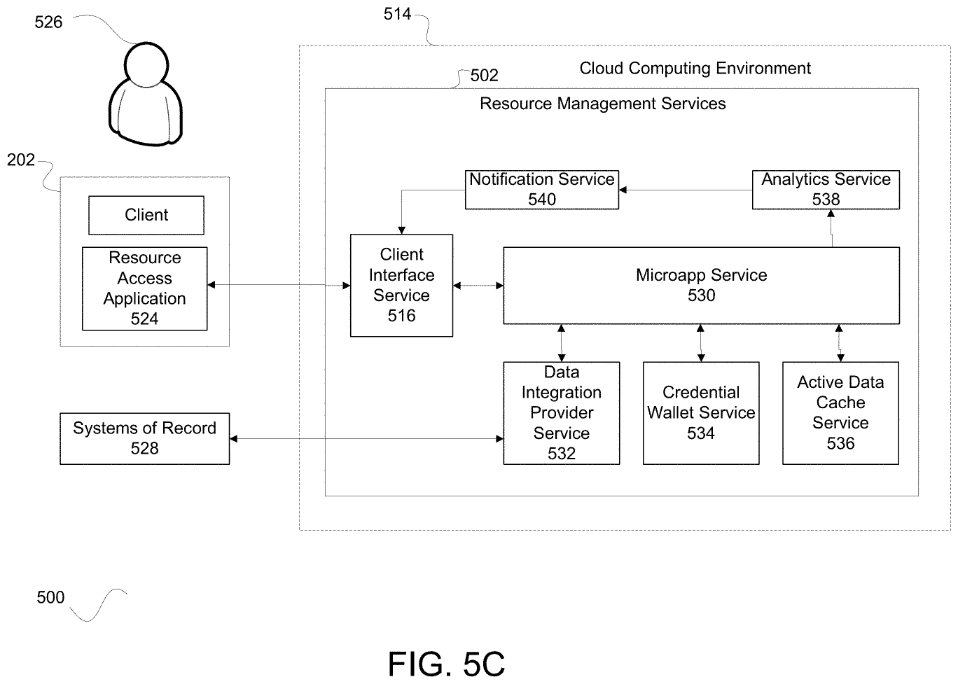

FIG. 5A is a block diagram of an example system 500 in which one or more resource management services 502 may manage and streamline access by one or more clients 202 to one or more resource feeds 506 (via one or more gateway services 508) and/or one or more software-as-a-service (SaaS) applications 510. In particular, the resource management service(s) 502 may employ an identity provider 512 to authenticate the identity of a user of a client 202 and, following authentication, identify one of more resources the user is authorized to access. In response to the user selecting one of the identified resources, the resource management service(s) 502 may send appropriate access credentials to the requesting client 202, and the client 202 may then use those credentials to access the selected resource. For the resource feed(s) 506, the client 202 may use the supplied credentials to access the selected resource via a gateway service 508. For the SaaS application(s) 510, the client 202 may use the credentials to access the selected application directly.

The client(s) 202 may be any type of computing devices capable of accessing the resource feed(s) 506 and/or the SaaS application(s) 510, and may, for example, include a variety of desktop or laptop computers, smartphones, tablets, etc. The resource feed(s) 506 may include any of numerous resource types and may be provided from any of numerous locations. In some embodiments, for example, the resource feed(s) 506 may include one or more systems or services for providing virtual applications and/or desktops to the client(s) 202, one or more file repositories and/or file sharing systems, one or more secure browser services, one or more access control services for the SaaS applications 510, one or more management services for local applications on the client(s) 202, one or more internet enabled devices or sensors, etc. Each of the resource management service(s) 502, the resource feed(s) 506, the gateway service(s) 508, the SaaS application(s) 510, and the identity provider 512 may be located within an on-premises data center of an organization for which the system 500 is deployed, within one or more cloud computing environments, or elsewhere.

FIG. 5B is a block diagram showing an example implementation of the system 500 shown in FIG. 5A in which various resource management services 502 as well as a gateway service 508 are located within a cloud computing environment 514. The cloud computing environment may, for example, include Microsoft Azure Cloud, Amazon Web Services, Google Cloud, or IBM Cloud.

For any of illustrated components (other than the client 202) that are not based within the cloud computing environment 514, cloud connectors (not shown in FIG. 5B) may be used to interface those components with the cloud computing environment 514. Such cloud connectors may, for example, run on Windows Server instances hosted in resource locations and may create a reverse proxy to route traffic between the site(s) and the cloud computing environment 514. In the illustrated example, the cloud-based resource management services 502 include a client interface service 516, an identity service 518, a resource feed service 520, and a single sign-on service 522. As shown, in some embodiments, the client 202 may use a resource access application 524 to communicate with the client interface service 516 as well as to present a user interface on the client 202 that a user 526 can operate to access the resource feed(s) 506 and/or the SaaS application(s) 510. The resource access application 524 may either be installed on the client 202, or may be executed by the client interface service 516 (or elsewhere in the system 500) and accessed using a web browser (not shown in FIG. 5B) on the client 202.

As explained in more detail below, in some embodiments, the resource access application 524 and associated components may provide the user 526 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 524 is launched or otherwise accessed by the user 526, the client interface service 516 may send a sign-on request to the identity service 518. In some embodiments, the identity provider 512 may be located on the premises of the organization for which the system 500 is deployed. The identity provider 512 may, for example, correspond to an on-premises Windows Active Directory. In such embodiments, the identity provider 512 may be connected to the cloud-based identity service 518 using a cloud connector (not shown in FIG. 5B), as described above. Upon receiving a sign-on request, the identity service 518 may cause the resource access application 524 (via the client interface service 516) to prompt the user 526 for the user's authentication credentials (e.g., user-name and password). Upon receiving the user's authentication credentials, the client interface service 516 may pass the credentials along to the identity service 518, and the identity service 518 may, in turn, forward them to the identity provider 512 for authentication, for example, by comparing them against an Active Directory domain. Once the identity service 518 receives confirmation from the identity provider 512 that the user's identity has been properly authenticated, the client interface service 516 may send a request to the resource feed service 520 for a list of subscribed resources for the user 526.

In other embodiments (not illustrated in FIG. 5B), the identity provider 512 may be a cloud-based identity service, such as a Microsoft Azure Active Directory. In such embodiments, upon receiving a sign-on request from the client interface service 516, the identity service 518 may, via the client interface service 516, cause the client 202 to be redirected to the cloud-based identity service to complete an authentication process. The cloud-based identity service may then cause the client 202 to prompt the user 526 to enter the user's authentication credentials. Upon determining the user's identity has been properly authenticated, the cloud-based identity service may send a message to the resource access application 524 indicating the authentication attempt was successful, and the resource access application 524 may then inform the client interface service 516 of the successfully authentication. Once the identity service 518 receives confirmation from the client interface service 516 that the user's identity has been properly authenticated, the client interface service 516 may send a request to the resource feed service 520 for a list of subscribed resources for the user 526.

For each configured resource feed, the resource feed service 520 may request an identity token from the single sign-on service 522. The resource feed service 520 may then pass the feed-specific identity tokens it receives to the points of authentication for the respective resource feeds 506. Each resource feed 506 may then respond with a list of resources configured for the respective identity. The resource feed service 520 may then aggregate all items from the different feeds and forward them to the client interface service 516, which may cause the resource access application 524 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 510 to which the user 526 has subscribed. The lists of local applications and the SaaS applications 510 may, for example, be supplied by resource feeds 506 for respective services that manage which such applications are to be made available to the user 526 via the resource access application 524. Examples of SaaS applications 510 that may be managed and accessed as described herein include Microsoft Office 365 applications, SAP SaaS applications, Workday applications, etc.

For resources other than local applications and the SaaS application(s) 510, upon the user 526 selecting one of the listed available resources, the resource access application 524 may cause the client interface service 516 to forward a request for the specified resource to the resource feed service 520. In response to receiving such a request, the resource feed service 520 may request an identity token for the corresponding feed from the single sign-on service 522. The resource feed service 520 may then pass the identity token received from the single sign-on service 522 to the client interface service 516 where a launch ticket for the resource may be generated and sent to the resource access application 524. Upon receiving the launch ticket, the resource access application 524 may initiate a secure session to the gateway service 508 and present the launch ticket. When the gateway service 508 is presented with the launch ticket, it may initiate a secure session to the appropriate resource feed and present the identity token to that feed to seamlessly authenticate the user 526. Once the session initializes, the client 202 may proceed to access the selected resource.

When the user 526 selects a local application, the resource access application 524 may cause the selected local application to launch on the client 202. When the user 526 selects a SaaS application 510, the resource access application 524 may cause the client interface service 516 request a one-time uniform resource locator (URL) from the gateway service 508 as well a preferred browser for use in accessing the SaaS application 510. After the gateway service 508 returns the one-time URL and identifies the preferred browser, the client interface service 516 may pass that information along to the resource access application 524. The client 202 may then launch the identified browser and initiate a connection to the gateway service 508. The gateway service 508 may then request an assertion from the single sign-on service 522. Upon receiving the assertion, the gateway service 508 may cause the identified browser on the client 202 to be redirected to the logon page for identified SaaS application 510 and present the assertion. The SaaS may then contact the gateway service 508 to validate the assertion and authenticate the user 526. Once the user has been authenticated, communication may occur directly between the identified browser and the selected SaaS application 510, thus allowing the user 526 to use the client 202 to access the selected SaaS application 510.

In some embodiments, the preferred browser identified by the gateway service 508 may be a specialized browser embedded in the resource access application 524 (when the resource application is installed on the client 202) or provided by one of the resource feeds 506 (when the resource application 524 is located remotely), e.g., via a secure browser service. In such embodiments, the SaaS applications 510 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 506) for assessment of its security risk by a web filtering service. For approved URLs, the specialized browser may be permitted to access the link. For suspicious links, however, the web filtering service may have the client interface service 516 send the link to a secure browser service, which may start a new virtual browser session with the client 202, and thus allow the user to access the potentially harmful linked content in a safe environment.

In some embodiments, in addition to or in lieu of providing the user 526 with a list of resources that are available to be accessed individually, as described above, the user 526 may instead be permitted to choose to access a streamlined feed of event notifications and/or available actions that may be taken with respect to events that are automatically detected with respect to one or more of the resources. This streamlined resource activity feed, which may be customized for each user 526, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 526 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 528 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 516 discussed above, the illustrated services include a microapp service 530, a data integration provider service 532, a credential wallet service 534, an active data cache service 536, an analytics service 538, and a notification service 540. In various embodiments, the services shown in FIG. 5C may be employed either in addition to or instead of the different services shown in FIG. 5B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 524 without having to launch the native application. The system shown in FIG. 5C may, for example, aggregate relevant notifications, tasks, and insights, and thereby give the user 526 a dynamic productivity tool. In some embodiments, the resource activity feed may be intelligently populated by utilizing machine learning and artificial intelligence (AI) algorithms. Further, in some implementations, microapps may be configured within the cloud computing environment 514, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 528 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 532, may, for example, support REST API, JSON, OData-JSON, and 6ML. As explained in more detail below, the data integration provider service 532 may also write back to the systems of record, for example, using OAuth2 or a service account.

In some embodiments, the microapp service 530 may be a single-tenant service responsible for creating the microapps. The microapp service 530 may send raw events, pulled from the systems of record 528, to the analytics service 538 for processing. The microapp service may, for example, periodically pull active data from the systems of record 528.

In some embodiments, the active data cache service 536 may be single-tenant and may store all configuration information and microapp data. It may, for example, utilize a per-tenant database encryption key and per-tenant database credentials.

In some embodiments, the credential wallet service 534 may store encrypted service credentials for the systems of record 528 and user OAuth2 tokens.

In some embodiments, the data integration provider service 532 may interact with the systems of record 528 to decrypt end-user credentials and write back actions to the systems of record 528 under the identity of the end-user. The write-back actions may, for example, utilize a user's actual account to ensure all actions performed are compliant with data policies of the application or other resource being interacted with.

In some embodiments, the analytics service 538 may process the raw events received from the microapps service 530 to create targeted scored notifications and send such notifications to the notification service 540.

Finally, in some embodiments, the notification service 540 may process any notifications it receives from the analytics service 538. In some implementations, the notification service 540 may store the notifications in a database to be later served in a notification feed. In other embodiments, the notification service 540 may additionally or alternatively send the notifications out immediately to the client 202 as a push notification to the user 526.

In some embodiments, a process for synchronizing with the systems of record 528 and generating notifications may operate as follows. The microapp service 530 may retrieve encrypted service account credentials for the systems of record 528 from the credential wallet service 534 and request a sync with the data integration provider service 532. The data integration provider service 532 may then decrypt the service account credentials and use those credentials to retrieve data from the systems of record 528. The data integration provider service 532 may then stream the retrieved data to the microapp service 530. The microapp service 530 may store the received systems of record data in the active data cache service 536 and also send raw events to the analytics service 538. The analytics service 538 may create targeted scored notifications and send such notifications to the notification service 540. The notification service 540 may store the notifications in a database to be later served in a notification feed and/or may send the notifications out immediately to the client 202 as a push notification to the user 526.

In some embodiments, a process for processing a user-initiated action via a microapp may operate as follows. The client 202 may receive data from the microapp service 530 (via the client interface service 516) to render information corresponding to the microapp. The microapp service 530 may receive data from the active data cache service 536 to support that rendering. The user 526 may invoke an action from the microapp, causing the resource access application 524 to send that action to the microapp service 530 (via the client interface service 516). The microapp service 530 may then retrieve from the credential wallet service 534 an encrypted Oauth2 token for the system of record for which the action is to be invoked, and may send the action to the data integration provider service 532 together with the encrypted Oath2 token. The data integration provider service 532 may then decrypt the Oath2 token and write the action to the appropriate system of record under the identity of the user 526. The data integration provider service 532 may then read back changed data from the written-to system of record and send that changed data to the microapp service 530. The microapp service 532 may then update the active data cache service 536 with the updated data and cause a message to be sent to the resource access application 524 (via the client interface service 516) notifying the user 526 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistance through either the resource access application 524 or directly from another resource, such as Microsoft Teams. This feature may allow employees to work efficiently, stay organized, and deliver only the specific information they're looking for.

Dynamic Recommendation Engine

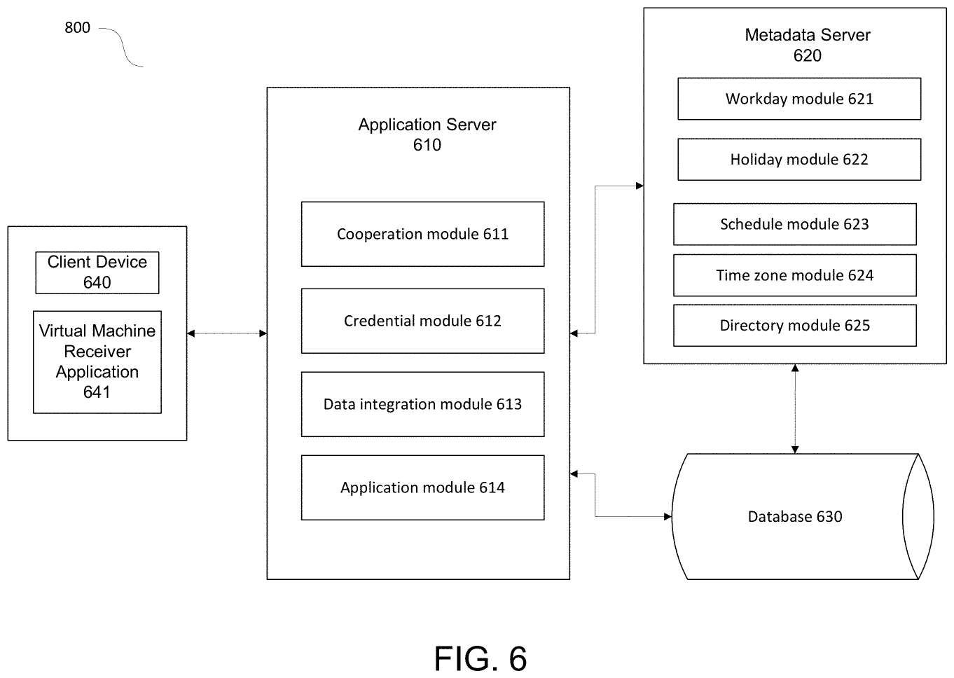

FIG. 6 depicts an illustrative system 600 for generating event recommendations. The system 600 may include a client device 640, an application server 610, a metadata server 620, and/or a database 630. The client device 640 may comprise, for example, any device of the client devices 240, the computing device 201, the device 103, and/or any component described in connection with FIGS. 1-5. The client device may include a virtual machine receiver application 641 (e.g., the virtual machine receiver application discussed above in connection with FIG. 3). The client device 640 may be configured to communicate with application server 610 to determine recommendations for events. An event may include a meeting (e.g., in person and/or virtual), a work assignment, or any other occurrence where two or more people work together to accomplish a goal. An event may include an action or assignment that is assigned to one person. The client device 640 (e.g., the virtual machine receiver application 641) may be configured to schedule an event and/or request recommendations for scheduling an event. The client device 640 may send a request to the application server 610 for event recommendations (e.g., to determine a time for the event, to determine participants for the event, etc.).

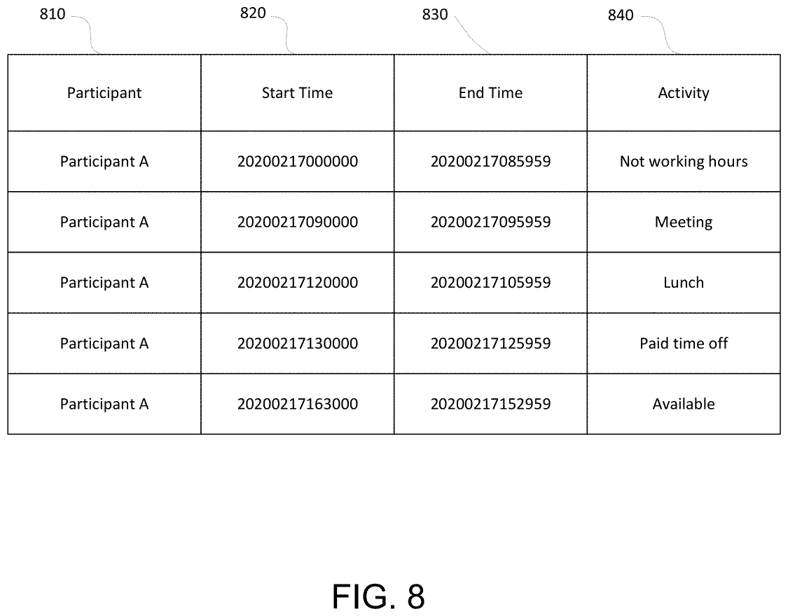

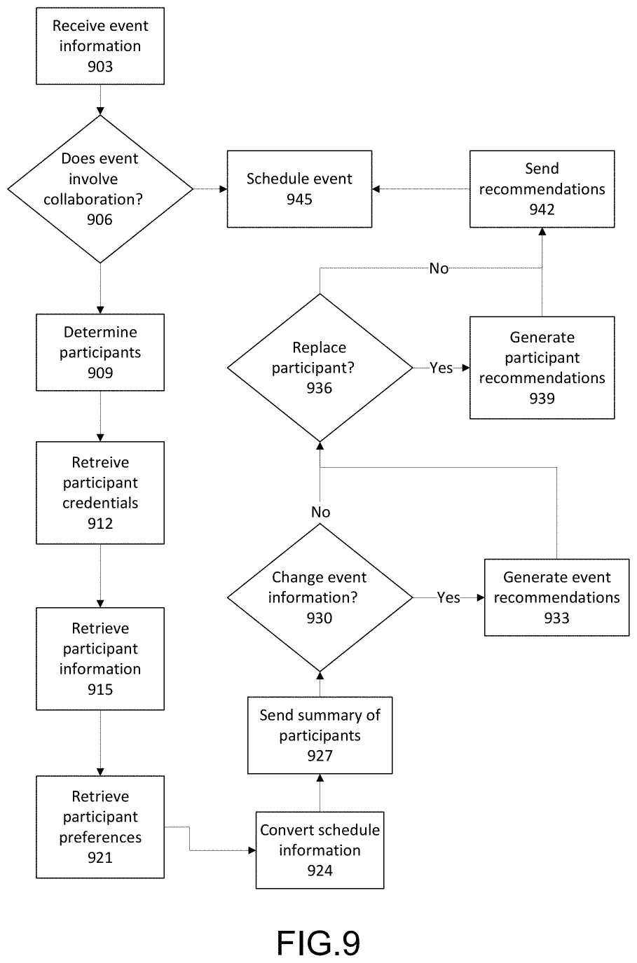

The application server 610 may include a cooperation module 611, a credential module 612, a data integration module 613, and/or an application module 614. Alternatively, each module may operate on one or more separate servers. The cooperation module 611 may be configured to receive requests for events (e.g., to schedule an event) from the client device 640. The cooperation module 611 may retrieve credentials for each participant and use the credentials to obtain schedule information for each participant. The cooperation module 611 may use the schedule information to determine a recommendation for a time and/or participants for the event as discussed in more detail in connection with FIGS. 8, 9A, and 9B below.

The application module 614 may be configured to generate event information (e.g., a user interface for displaying event information, a user interface to display in an activity feed for a participant, etc.). The application module 614 may store event information related to the events in the database 630. The application module 614 may comprise the microapp service 530 described in connection with FIGS. 5A-5C and may perform any of the functions performed by the microapp service 530. The credential module 612 may be configured to store credentials (e.g., encrypted credentials) that may be used to obtain schedule information (e.g., from the metadata server 620). The credential module 612 may comprise the credential wallet service 534 described in connection with FIGS. 5A-5C and may perform any of the functions performed by the credential wallet service 534. The data integration module 613 may be configured to retrieve data from the database 630 (e.g., to populate a cache of the application module 614). The data integration module 613 may be configured to retrieve information from the metadata server 620 (e.g., by using a credential obtained from the credential module 612) for use in generating event recommendations. The data integration module 613 may comprise the data integration provider service 532 described in connection with FIGS. 5A-5C and may perform any of the functions performed by the data integration provider service 532.

The metadata server 620 may be configured to access one or more SaaS systems and/or services to retrieve schedule information for employees of a company and/or participants of an event. The metadata server 620 may use a credential from a participant or employee to access one or more systems/services. The metadata server 620 may be configured to use the credential to access multiple services for information without requiring an employee/participant to login to each service separately. The metadata server 620 may comprise the active data cache service 536 described in connection with FIGS. 5A-5C and may perform any of the functions performed by the active data cache service 536. The metadata server 620 may include a workday module 621, a holiday module 622, a schedule module 623, a time zone module 624, and/or a directory module 625. Alternatively, each module may operate on one or more separate servers. Each module may be configured to retrieve schedule information from the database 630. For example, the workday module 621 may be configured to retrieve work schedule information (e.g., paid time off information). For example, the holiday module 622 may be configured to retrieve holiday information. Additionally or alternatively, the schedule module 623 may be configured to obtain schedule information including work days and/or hours of a participant (e.g., which days/hours a participant works). The schedule information may indicate which days are holidays (e.g., in the country of the participant), and/or which days the participant is taking time off from work (e.g., paid time off). The schedule information may indicate dates and times that are scheduled for events for each participant (e.g., the dates and times of meetings that have been scheduled). The schedule information may indicate dates and times that each participant is available. The time zone module 624 may be configured to obtain schedule information including the time zone of a participant (e.g., so that the schedule information of each participant in an event can be converted to one time zone). The directory module 625 may be configured to obtain employee information of participants. The employee information may include occupation (e.g., job title), experience level, and/or skills (e.g., writing, programming, language, construction, or any other skill). The employee information may indicate for a particular employee, other employees within the company that have a similar skillset, experience level, and/or occupation.

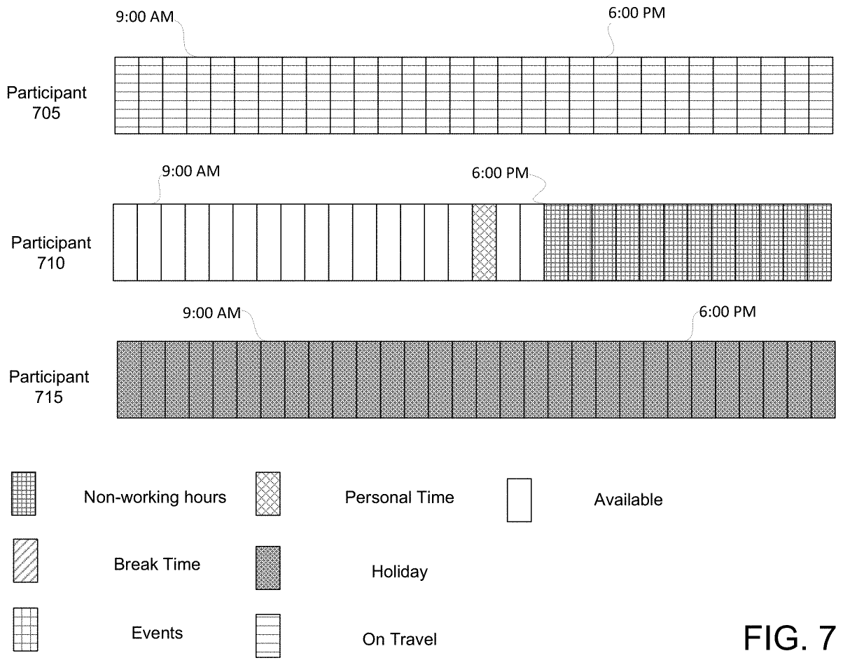

FIG. 7 shows example schedules for participants in an event. Participants in an event may have schedules that include working hours, non-working hours, break times, scheduled events (e.g., meetings or other events that have already been scheduled), personal time (e.g., paid time off), holiday or vacation time, time when the participant is unavailable due to travel, etc. Participant 705 may be in location A, participant 710 may be in location B, and participant 715 may be in location C. Each location A-C may be in different time zones. The system 600 may be configured to retrieve information for each participant and determine recommendations for times for an event. The system 600 may be configured to recommend alternative participants, for example, if a recommended time cannot be found by the system 600.

FIG. 8 shows example data 800 that may be used by the system 600. The data 800 may be stored in the database 630. The data may indicate a start time in a start time field 820, an end time in an end time field 830 for an activity in an activity field 840. The data may also indicate the participant that the activity corresponds to, for example, in participant field 810. The start time 820 and/or end time 830 may be in a format that includes the year, month, day, hour, and minute for each activity (e.g., yyyymmddhhmm). The activity field 840 may indicate an activity for the corresponding start and end time. Activities may include non-working hours (e.g., time in the evening after work), available time (e.g., time that is available for scheduling an event), meal time, break time, scheduled time (e.g., meeting or other activity has already been scheduled during this time), holiday (e.g., public holiday and the participant is not working during this time), travel time (e.g., the participant may be unavailable because the participant is traveling), etc.

FIG. 9 shows an example method for generating event recommendations. Although one or more steps of the example method of FIG. 9 are described for convenience as being performed by the client device 640, application server 610, metadata server 620, and/or the database 630, one, some, or all of such steps may be performed by one or more other devices/modules, and/or steps may be distributed among one or more devices/modules, including any devices/modules such as those described in connection with FIGS. 1-8. One or more steps of the example method of FIG. 9 may be rearranged, modified, repeated, and/or omitted.

At step 903, the application server 610 may receive event information from the client device 640. The event information may indicate one or more participants, a date and/or time, and/or other information about an event (e.g., a description of the event). The event information may indicate a level of necessity for each participant. For example, a first participant may have a high level of necessity (e.g., the event may not occur without the first participant) and a second participant may have a low level of necessity (e.g., the event may occur without the second participant). At step 906, the application server 610 may determine whether the event involves collaboration. For example, the application server 610 may determine whether the event information includes more than one participant. Step 945 may be performed, for example, if the application server 610 determines that the event does not involve collaboration. Step 909 may be performed, for example, if it is determined that the event involves collaboration.

At step 909, the application server 610 may determine participants for the event indicated by the event information received in step 903. For example, the event information may include identifiers of the participants (e.g., employee IDs, names, etc.) and the application server 610 may use the identifiers to determine the participants. At step 912, the application server 610 may retrieve participant credentials. For example, the application server 610 may retrieve one or more credentials for each participant determined in step 909. The credentials may be retrieved via the credential module 612. The credentials may be configured to allow access to participant information (e.g., employee information, preference information, and/or schedule information).

At step 915, the application server 910 may retrieve information for participants determined in step 909. For example, the application server 910 may retrieve schedule and/or employee information for each participant. The employee information may include any employee information discussed in connection with FIG. 6 above. The schedule information may include any schedule information discussed above in connection with FIGS. 5-8. For example the schedule information may indicate working hours, scheduled events, available time, break time (e.g., in the middle of work hours), holiday time (e.g., for a country of the participant), time zone, travel time, or any other activity/event time for a participant. The application server 910 may use a credential to validate itself to the metadata server 620 and obtain the schedule information from the metadata server 620.

At step 921, the application server 910 may retrieve participant preferences (e.g., from the database 630). The participant preferences may indicate when a participant prefers a particular type of event to be scheduled. The participant preferences may indicate a type of meeting and a time that the participant prefers the type of meeting to occur. For example, the type of meeting may indicate particular participants that will be present (e.g., a team member, a department within a company, external clients, etc.), the job title of participants that will be present in the meeting, and/or whether other participants in the meeting include the participant's boss. The type of event may indicate that the event concerns a particular subject matter (e.g., sales, engineering, finance, product design, etc.). The type of event may indicate a purpose or structure of the event (e.g., planning, educational, presentation, conference call). The participant preferences may indicate what time a particular type of event should occur (e.g., morning, afternoon, evening). The participant preferences may indicate what day (e.g., day of the week, day of the month, and/or time of year) an event should occur. For example, preferences may indicate that a participant prefers to have meetings with an engineering team in the morning and/or the first week of every quarter of the year.

The system 600 may learn a participant's preferences over time (e.g., using a machine learning model). For example, the system 600 may learn which events the participant participated in (e.g., joined, attended, etc.) and at what times. The system 600 may learn any proposals a participant made to change the event. The system 600 may record or update preferences of a participant based on the preferences the system 600 learns. The system 600 may update preferences of one user based on preferences the system 600 learns about a similar user (e.g., similar experience level, job title, etc.). The system 600 may use the preferences to generate event recommendations and/or participant recommendations (e.g., as described in connection with steps 933 and 939 described below).

At step 924, the application server 610 may convert schedule information into a consistent format. For example, one or more participants determined in step 909 may be located in different time zones. The application server 610 may convert or adjust the schedule information of each participant into the same time zone (e.g., the time zone associated with a user that sent the event information to the application server 610 in step 903).

At step 927, the application server 610 may send a summary of schedule information of participants to the client device 640. The client device may display a summary of the schedule information for a user that is scheduling the event. The summary may indicate whether a participant is available during a time indicated by the event information received in step 903. The summary may indicate what activity a participant has scheduled during a time indicated by the event information received in step 903.

At step 930, the application server 610 may determine whether a portion of the event information should be changed. For example, the application server 610 may determine whether the time of the event should be changed. The application server 610 may compare schedule information for each participant to determine whether each participant determined in step 909 is available at the time indicated by the event information. Step 933 may be performed, for example, if not every participant is available at the event time. The application server 610 may determine whether each participant's event preferences are met by the time indicated in the event information. Step 933 may be performed, for example, if not every participant's event preferences are met.

At step 933, the application server 610 may generate recommendations to change the event information (e.g., the time of the event). The application server 610 may compare the schedule information of each participant to determine one or more recommendations to send to the client device 640. The recommendations may indicate that the time requested in step 903 is not available for all participants. For example, a recommendation may indicate which participants are not available at the time requested. A recommendation may indicate a time that is available for all participants. Additionally or alternatively, a recommendation may indicate a time that matches one or more participant's preferences. For example, a recommendation may indicate which time matches the largest number of participant's preferences. A recommendation may indicate that the time indicated by the event information received in step 903 does not match one or more participant's preferences. A recommendation may indicate a time that matches a greater number of participant's preferences than the time requested in step 903.

The one or more recommendations may weight some participant's preferences over others. For example, the application server 610 may determine a seniority level of each participant (e.g., based on the number of years at a company, job title, and/or other employee information). The application server 610 may use the seniority level of each participant to weight each participant's preferences. For example, if a conflict exists between the preferences of two participants, the application server 610 may follow the preference of the participant with a higher seniority level (e.g., the preference of the participant with the lower seniority level may be ignored). A recommendation may indicate why the recommendation is being made. For example, a recommendation may indicate that a time is being recommended because it matches more closely to a participant's preferences. For example, a recommendation may indicate that a time is being recommended because the originally requested time is not available for a particular participant. The application server 610 may weight a first participant's preferences over a second participant's preferences, for example, if the first participant is determined to have a higher level of necessity than the second participant. The second participant's preferences (e.g., the portion of the second participant's preferences that conflict with the first participant's preferences) may be ignored, for example, if the second participant's preferences are weighted lower than the first participant's preferences.

At step 936, the application server 610 may determine whether a participant should be replaced. For example, the application server 610 may determine that there is no time that matches each participant's availability and/or preferences. The application server 610 may determine that a participant should be replaced, for example, if the application server 610 is unable to determine a recommended time in step 933.

At step 939, the application server 610 may generate participant recommendations. The application server 610 may determine people that are not indicated by the event information received in step 903. The application server 610 may determine that one or more participants indicated by the event information be replaced by other participants. For example, a first participant may work in a time zone that is difficult to schedule with other participants indicated by the event information (e.g., For example, the time difference between time zones may exceed a threshold). The application server 610 may determine a person not indicated by the event information that is similar (e.g., same job title, same number of years of experience, etc.) to the first participant and may recommend replacing the first participant with the person (e.g., the time difference between the time zones of the person and one or more time zones of other participants does not exceed the threshold).

As an additional example, a first participant indicated by the event information may have a high seniority level and may prefer to have a type of meeting in the evening. A second participant indicated by the event information may prefer to have the type of meeting in the morning (e.g., a conflict exists between the preferences of the first and second participants). The application server 610 may determine a third participant that has one or more overlapping skills with the second participant. The application server 610 may generate a recommendation to replace the second participant with the third participant (e.g., because the second participant is at a lower seniority level than the first participant).

The recommendation may indicate why the replacement recommendation is being made. For example the recommendation may indicate why the original participant is unavailable and/or why the replacement participant was chosen as a recommendation (e.g., the replacement has a similar job title, experience level, etc.). Additionally or alternatively, the application server 610 may recommend that people not indicated by the event information be added to the event (e.g., by determining that a participant has been included in similar events in the past). Additionally or alternatively, a recommendation may indicate that participants with a low level of necessity (e.g., the level of necessity falls below a threshold) should be removed from the event.

At step 942, the application server 610 may send the recommendations generated in step 939 and/or step 933 to the client device 640. A user of the client device 640 may use the recommendations to modify the event information. At step 945, the event may be scheduled. For example, notifications containing event information (e.g., event description, time, participants, etc.) may be sent to one or more devices associated with participants of the event.

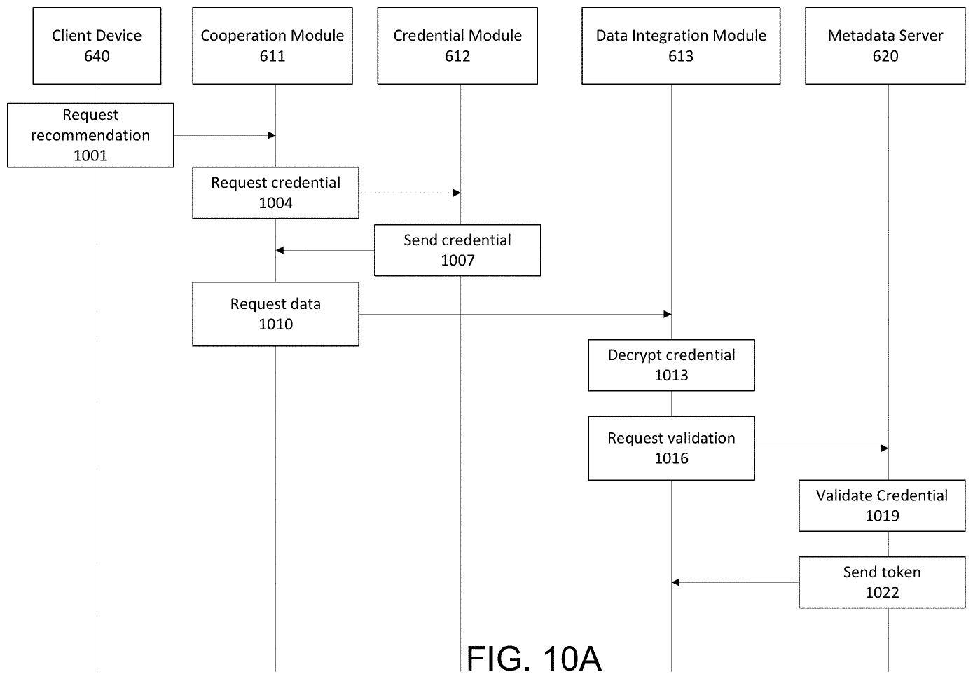

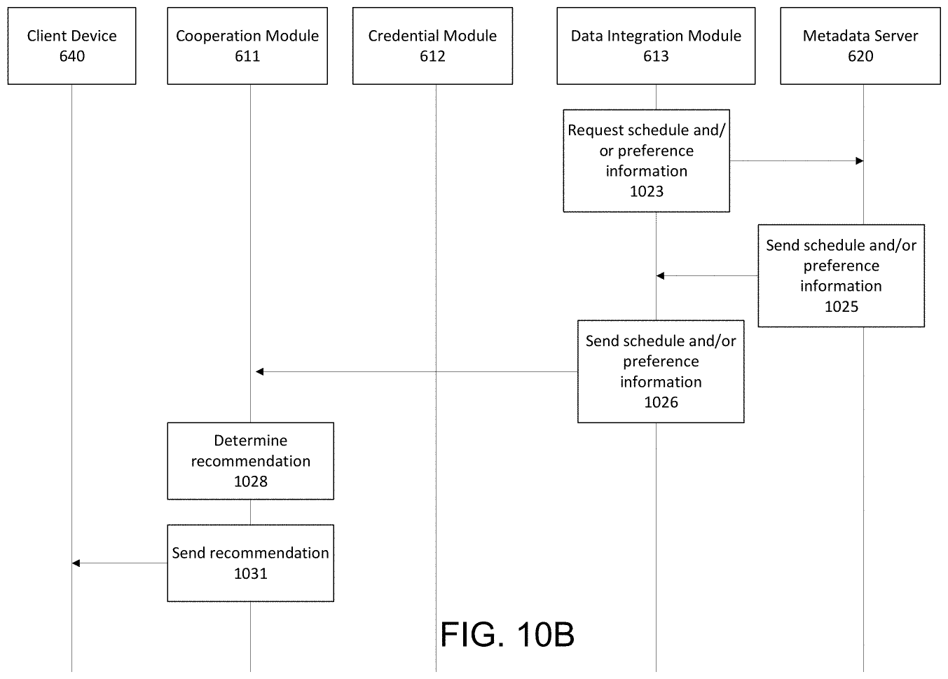

FIGS. 10A-10B show an example method for generating schedule recommendations. Although one or more steps of the example method of FIGS. 10A-10B are described for convenience as being performed by the client device 640, the cooperation module 611, the credential module 612, the data integration module 613, and/or the metadata server 620, one, some, or all of such steps may be performed by one or more other devices/modules (e.g., the application server 610, the database 630, etc.) and/or steps may be distributed among one or more devices, including any devices such as those described in connection with FIGS. 1-8. One or more steps of the example method of FIGS. 10A-10B may be rearranged, modified, repeated, and/or omitted.

At step 1001, the client device send a request for a recommendation (e.g., for a time and/or participants for an event) to the cooperation module 611. The cooperation service 611 may parse the request to determine participants for the event and/or a time for the event.

At step 1004, the cooperation module 611 may request one or more credentials (e.g., one credential for each participant of the event) from the credential module 612. The one or more credentials may be used to obtain (e.g., gain access) to data corresponding to each participant (e.g., schedule information, preference information, employee information etc.). At step 1007, the credential module 612 may send one or more requested credentials to the cooperation module 611. The one or more credentials may be encrypted.

At step 1010, the cooperation module 611 may send a request for data to the data integration module 613. The request may include the participants for whom data is requested. The request may include the one or more credentials received in step 1007. At step 1013, the data integration module 613 may decrypt the one or more credentials received in step 1010. The data integration module 613 may use the one or more credentials to retrieve schedule and/or preference information (e.g., for each participant) from the metadata server 620.

At step 1016, the data integration module 613 may send a request to the metadata server 620 to validate the one or more credentials. The request may include the one or more credentials. At step 1019, the metadata server 620 (e.g., the directory module 625) may determine whether the one or more credentials are valid. The metadata server 620 may generate one or more tokens (e.g., a single sign on token) for each of the one or more credentials that are valid. At step 1022, the metadata server 620 may send the one or more tokens to the data integration module 613.

At step 1023, the data integration module 613 may send one or more requests for schedule and/or participant preference information to the metadata server 620. The one or more requests may include a token received from the metadata server 620 in step 1022. One or more requests may be sent for each participant indicated in the request sent in step 1001. For example, the data integration module 613 may send a request for information indicating when a participant has paid time off from work. For example, the data integration module 613 may send a request for holiday information (e.g., information that indicates what days are public holidays in the geographic location of a participant). For example, the data integration module 613 may send a request for information indicating when a participant has scheduled meetings (e.g., appointments, business meetings, etc.). For example, the data integration module 613 may send a request for time zone information that indicates within what time zone one or more participants is located. The data integration module 613 may send a request for schedule information, preference information, or any other type of information described in connection with FIGS. 5-9 above.

At step 1025, the metadata server 620 may send schedule and/or preference information to the data integration module 613 in response to the one or more requests received in step 1023. The metadata server 620 may validate a token contained in a request before sending schedule and/or preference information. For example, the metadata server 620 may send paid time off information for one or more participants. For example, the metadata server 620 may send holiday information for one or more participants. For example, the metadata server 620 may send meeting and/or appointment information for one or more participants. For example, the metadata server 620 may send time zone information for one or more participants. The metadata server 620 may send a response containing schedule information, preference information, or any other type of information described in connection with FIGS. 5-9 above.

At step 1026, the data integration module 613 may send the schedule and/or preference information received from the metadata server 620 to the cooperation module 611. The data integration module 613 may convert all of the data into one consistent format before sending the data (e.g., time may be converted to reflect time in one time zone).

At step 1028, the cooperation module 611 may determine a recommendation for the event information sent in step 1001. The cooperation module 611 may determine a recommendation using the schedule and/or preference information received in step 1026. The cooperation module 611 may determine a recommendation for a time for the event (e.g., as described above in connection with steps 930-933 of FIG. 9). Additionally or alternatively, the cooperation module 611 may determine a recommendation for a participant replacement (e.g., as described above in connection with steps 936-939 of FIG. 9). At step 1031, the cooperation module 611 may send the recommendation to the client device 640.

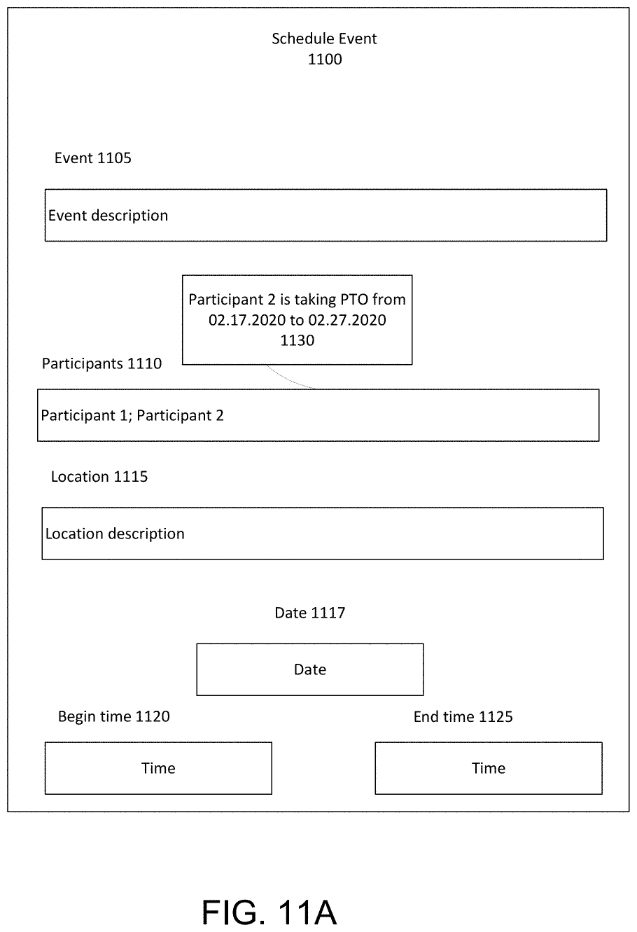

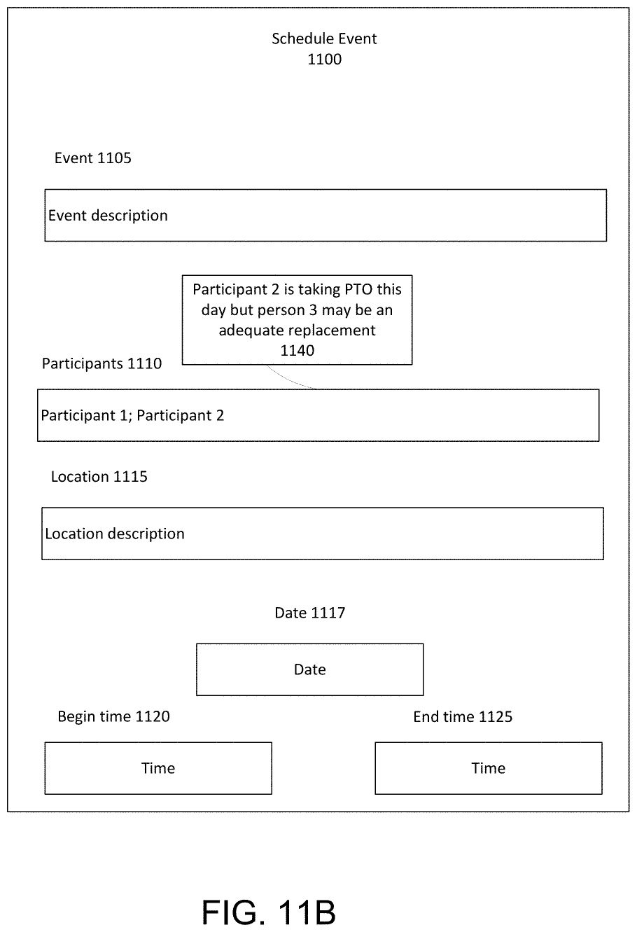

FIG. 11 shows an example graphical user interface (GUI) 1100. The GUI 1100 may be used to schedule an event and/or to request recommendations from the application server 610. The information contained in the GUI 1100 may be sent by the client device 640 in a request for a recommendation (e.g., as described in connection with step 803 of FIG. 8 and/or step 901 of FIG. 9A). The GUI 1100 may include an event field 1105. The event field 1105 may include a description of the event (e.g., indicating the type of event). For example, the event field 1105 may describe the purpose of the event. The GUI 1100 may include a participants field 1110. The participants field 1110 may indicate which participants a user wants to invite to the event. For example, the participants field 1110 may include the names of each participant. The GUI 1100 may include a location field 1115. The location field 1115 may describe the location of the event. The GUI 1100 may include a date field 1117 that indicates the day, month, and/or year of the event. The GUI 1100 may include a start time field 1120 that indicates the time the event will start at. The GUI 1100 may include an end time field 1125 that indicates the time the event will end. The GUI 1100 may be configured to display one or more summaries (e.g., summary 1130). The summary 1130 may appear as a pop-up bubble or any other GUI feature. The summary 1130 may indicate information about the participants in the participants field 1110. The summary may indicate if there is a schedule conflict with one or more participants. For example, the summary may indicate that a participant has paid time off on a day indicated in the date field 1117. Referring to FIG. 11B, the GUI 1100 may be configured to display one or more recommendations (e.g., the recommendation 1140). The recommendation 1140 may indicate a recommended time. Additionally or alternatively, the recommendation 1140 may indicate a recommended replacement participant for a participant indicated in the participants field 1110. The one or more recommendations may include any recommendation described in connection with FIGS. 5-10 above.

The following paragraphs (M1) through (M7) describe examples of methods that may be implemented in accordance with the present disclosure.

(M1) A method comprising receiving, by a server and from a user device, a request to schedule an event, wherein the request indicates a first plurality of participants for the event; receiving participant preference information corresponding to the plurality of participants, wherein the participant preference information indicates, for each participant, a type of event and a preferred time for the type of event, wherein the type of event indicates a second plurality of participants associated with the type of event; receiving scheduling information corresponding to the first plurality of participants, wherein the scheduling information indicates availability for each participant of the first plurality of participants; generating, based on the participant preference information and the scheduling information, a recommendation for a time to schedule the event; and sending the recommendation to the user device.

(M2) A method may be performed as described in paragraph (M1), further comprising: determining a level of necessity for each participant of the plurality of participants; and weighting, based on the level of necessity for each participant, participant preference information of the plurality of participants, wherein the recommendation is based on the weighting.

(M3) A method may be performed as described in any of paragraphs (M1) through (M2), wherein the participant preference information further indicates a second type of event and a time when the second type of event should not occur.

(M4) A method may be performed as described in any of paragraphs (M1) through (M3), wherein the receiving scheduling information corresponding to the first plurality of participants comprises receiving scheduling information from a plurality of systems.

(M5) A method may be performed as described in any of paragraphs (M1) through (M4), further comprising: determining, based on a time indicated by the request and the scheduling information, that the time corresponds to a non-preferred time of a first participant of the first plurality of participants; and sending, to the user device, a recommendation to remove the first participant.

(M6) A method may be performed as described in paragraph (M5), wherein the recommendation to remove the first participant is based on a determination of a level of necessity of the first participant.

(M7) A method may be performed as described in any of paragraphs (M1) through (M6), further comprising: determining, based on time indicated by the request and the participant preference information, that a first participant of the first plurality of participants is unavailable; determining, based on employee information of the first participant and a machine learning model, a similarity metric that compares the first participant and a replacement participant; and sending, based on a determination that the similarity metric exceeds a threshold, a recommendation to replace the first participant with the replacement participant.

The following paragraphs (S1) through (S7) describe examples of systems that may be implemented in accordance with the present disclosure.

(S1) A system comprising: one or more processors; and a memory storing computer-readable instructions that, when executed by the one or more processors, configure the one or more processors to: receive, from a user device, a request to schedule an event, wherein the request indicates a first plurality of participants for the event; receive participant preference information corresponding to the plurality of participants, wherein the participant preference information indicates, for each participant, a type of event and a preferred time for the type of event, wherein the type of event indicates a second plurality of participants associated with the type of event; receive scheduling information corresponding to the first plurality of participants, wherein the scheduling information indicates availability for each participant of the first plurality of participants; generate, based on the participant preference information and the scheduling information, a recommendation for a time to schedule the event; and send the recommendation to the user device.

(S2) A system as described in paragraph (S1), wherein the instructions, when executed by the one or more processors, further configure the one or more processors to: determine a level of necessity for each participant of the plurality of participants; and weight, based on the level of necessity for each participant, participant preference information of the plurality of participants, wherein the recommendation is based on the weighting.

(S3) A system as described in any of paragraphs (S1) through (S2), wherein the participant preference information further indicates a second type of event and a time when the second type of event should not occur.

(S4) A system as described in any of paragraphs (S1) through (S3), wherein the receiving scheduling information corresponding to the first plurality of participants comprises receiving scheduling information from a plurality of systems.

(S5) A system as described in any of paragraphs (S1) through (S4), wherein the instructions, when executed by the one or more processors, further configure the one or more processors to: determine, based on a time indicated by the request and the scheduling information, that the time corresponds to a non-preferred time of a first participant of the first plurality of participants; and send, to the user device, a recommendation to remove the first participant.

(S6) A system as described in paragraph (S5), wherein the recommendation to remove the first participant is based on a determination of a level of necessity of the first participant.

(S7) A system as described in any of paragraphs (S1) through (S6), wherein the instructions, when executed by the one or more processors, further configure the one or more processors to: determine, based on time indicated by the request and the participant preference information, that a first participant of the first plurality of participants is unavailable; determine, based on employee information of the first participant and a machine learning model, a similarity metric that compares the first participant and a replacement participant; and send, based on a determination that the similarity metric exceeds a threshold, a recommendation to replace the first participant with the replacement participant.

The following paragraphs (CRM1) through (CRM6) describe examples of computer-readable media that may be implemented in accordance with the present disclosure.

(CRM1) A non-transitory machine-readable medium storing instructions, that when executed by one or more processors, cause the one or more processors to: receive, from a user device, a request to schedule an event, wherein the request indicates a first plurality of participants for the event; receive participant preference information corresponding to the plurality of participants, wherein the participant preference information indicates, for each participant, a type of event and a preferred time for the type of event, wherein the type of event indicates a second plurality of participants associated with the type of event; receive scheduling information corresponding to the first plurality of participants, wherein the scheduling information indicates availability for each participant of the first plurality of participants; generate, based on the participant preference information and the scheduling information, a recommendation for a time to schedule the event; and send the recommendation to the user device.

(CRM2) The non-transitory machine-readable medium as described in paragraph (CRM1), wherein the participant preference information further indicates a second type of event and a time when the second type of event should not occur.

(CRM3) The non-transitory machine-readable medium as described in any of paragraphs (CRM1) through (CRM2), wherein the receiving scheduling information corresponding to the first plurality of participants comprises receiving scheduling information from a plurality of systems.

(CRM4) The non-transitory machine-readable medium as described in any of paragraphs (CRM1) through (CRM3), wherein the instructions, when executed by the one or more processors, further configure the one or more processors to: determine, based on a time indicated by the request and the scheduling information, that the time corresponds to a non-preferred time of a first participant of the first plurality of participants; and send, to the user device, a recommendation to remove the first participant.

(CRM5) The non-transitory machine-readable medium as described in paragraph (CRM4), wherein the recommendation to remove the first participant is based on a determination of a level of necessity of the first participant.

(CRM6) The non-transitory machine-readable medium as described in any of paragraphs (CRM1) through (CRM5), wherein the instructions, when executed by the one or more processors, further configure the one or more processors to: determine, based on time indicated by the request and the participant preference information, that a first participant of the first plurality of participants is unavailable; determine, based on employee information of the first participant and a machine learning model, a similarity metric that compares the first participant and a replacement participant; and send, based on a determination that the similarity metric exceeds a threshold, a recommendation to replace the first participant with the replacement participant.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a server and from a user device, a request to schedule an event, wherein the request indicates a first plurality of participants for the event;
receiving participant preference information corresponding to the plurality of participants, wherein the participant preference information indicates, for each participant, a type of event and a preferred time for the type of event, wherein the type of event indicates a second plurality of participants associated with the type of event;
receiving scheduling information corresponding to the first plurality of participants, wherein the scheduling information indicates availability for each participant of the first plurality of participants;
generating, based on the participant preference information and the scheduling information, a recommendation for a time to schedule the event; and
sending the recommendation to the user device.

2. The method of claim 1, further comprising:
determining a level of necessity for each participant of the plurality of participants; and
weighting, based on the level of necessity for each participant, participant preference information of the plurality of participants, wherein the recommendation is based on the weighting.

3. The method of claim 1, wherein the participant preference information further indicates a second type of event and a time when the second type of event should not occur.

4. The method of claim 1, wherein the receiving scheduling information corresponding to the first plurality of participants comprises receiving scheduling information from a plurality of systems.

5. The method of claim 1, further comprising:
determining, based on a time indicated by the request and the scheduling information, that the time corresponds to a non-preferred time of a first participant of the first plurality of participants; and
sending, to the user device, a recommendation to remove the first participant.

6. The method of claim 5, wherein the recommendation to remove the first participant is based on a determination of a level of necessity of the first participant.

7. The method of claim 1, further comprising:
determining, based on time indicated by the request and the participant preference information, that a first participant of the first plurality of participants is unavailable;
determining, based on employee information of the first participant and a machine learning model, a similarity metric that compares the first participant and a replacement participant; and
sending, based on a determination that the similarity metric exceeds a threshold, a recommendation to replace the first participant with the replacement participant.

8. A system comprising:
one or more processors; and
a memory storing computer-readable instructions that, when executed by the one or more processors, configure the one or more processors to:
receive, from a user device, a request to schedule an event, wherein the request indicates a first plurality of participants for the event;
receive participant preference information corresponding to the plurality of participants, wherein the participant preference information indicates, for each participant, a type of event and a preferred time for the type of event, wherein the type of event indicates a second plurality of participants associated with the type of event;
receive scheduling information corresponding to the first plurality of participants, wherein the scheduling information indicates availability for each participant of the first plurality of participants;
generate, based on the participant preference information and the scheduling information, a recommendation for a time to schedule the event; and
send the recommendation to the user device.

9. The system of claim 8, wherein the instructions, when executed by the one or more processors, further configure the one or more processors to:
determine a level of necessity for each participant of the plurality of participants; and
weight, based on the level of necessity for each participant, participant preference information of the plurality of participants, wherein the recommendation is based on the weighting.

10. The system of claim 8, wherein the participant preference information further indicates a second type of event and a time when the second type of event should not occur.

11. The system of claim 8, wherein the receiving scheduling information corresponding to the first plurality of participants comprises receiving scheduling information from a plurality of systems.

12. The system of claim 8, wherein the instructions, when executed by the one or more processors, further configure the one or more processors to:
determine, based on a time indicated by the request and the scheduling information, that the time corresponds to a non-preferred time of a first participant of the first plurality of participants; and
send, to the user device, a recommendation to remove the first participant.

13. The system of claim 14, wherein the recommendation to remove the first participant is based on a determination of a level of necessity of the first participant.

14. The system of claim 8, wherein the instructions, when executed by the one or more processors, further configure the one or more processors to:
determine, based on time indicated by the request and the participant preference information, that a first participant of the first plurality of participants is unavailable;
determine, based on employee information of the first participant and a machine learning model, a similarity metric that compares the first participant and a replacement participant; and
send, based on a determination that the similarity metric exceeds a threshold, a recommendation to replace the first participant with the replacement participant.

15. A non-transitory machine-readable medium storing instructions, that when executed by one or more processors, cause the one or more processors to:
receive, from a user device, a request to schedule an event, wherein the request indicates a first plurality of participants for the event;
receive participant preference information corresponding to the plurality of participants, wherein the participant preference information indicates, for each participant, a type of event and a preferred time for the type of event, wherein the type of event indicates a second plurality of participants associated with the type of event;
receive scheduling information corresponding to the first plurality of participants, wherein the scheduling information indicates availability for each participant of the first plurality of participants;
generate, based on the participant preference information and the scheduling information, a recommendation for a time to schedule the event; and
send the recommendation to the user device.

16. The non-transitory machine-readable medium of claim 15, wherein the participant preference information further indicates a second type of event and a time when the second type of event should not occur.

17. The non-transitory machine-readable medium of claim 15, wherein the receiving scheduling information corresponding to the first plurality of participants comprises receiving scheduling information from a plurality of systems.

18. The non-transitory machine-readable medium of claim 15, wherein the instructions, when executed by the one or more processors, further configure the one or more processors to:
determine, based on a time indicated by the request and the scheduling information, that the time corresponds to a non-preferred time of a first participant of the first plurality of participants; and
send, to the user device, a recommendation to remove the first participant.

19. The non-transitory machine-readable medium of claim 18, wherein the recommendation to remove the first participant is based on a determination of a level of necessity of the first participant.

20. The non-transitory machine-readable medium of claim 15, wherein the instructions, when executed by the one or more processors, further configure the one or more processors to:
determine, based on time indicated by the request and the participant preference information, that a first participant of the first plurality of participants is unavailable;
determine, based on employee information of the first participant and a machine learning model, a similarity metric that compares the first participant and a replacement participant; and
send, based on a determination that the similarity metric exceeds a threshold, a recommendation to replace the first participant with the replacement participant.
